(19) United States
(12) Patent Application Publication
(10) Pub. No.: US 2024/0151871 A1
(43) Pub. Date: May 9, 2024

(54) A NODE MULTI-ELECTRODE RESISTIVITY MEASUREMENT SYSTEM

(71) Applicant: Beijing Orangelamp Geophysical Exploration Co., Ltd., Beijing City (CN)

(72) Inventors: Hanbing Wang, Beijing City (CN); Zhanguo Lu, Beijing City (CN); Wanpeng Zhang, Tianjin City (CN); Yongli Zhang, Liaocheng City (CN); Longqin Gao, Chengdu City (CN); Qiang Zhang, Tianjin City (CN); Yinze Wang, Sanhe City (CN)

(21) Appl. No.: 17/771,238

(22) PCT Filed: Jun. 23, 2021
(86) PCT No.: PCT/CN2021/101919

§ 371 Date: Apr. 22, 2022

(30) Foreign Application Priority Data
Jun. 25, 2020 (CN) 202010592856.8

(51) Int. Cl. G01V 3/08; G01V 3/02; G01V 3/36

(52) U.S. Cl. CPC G01V 3/083; G01V 3/02; G01V 3/36

(57) ABSTRACT

The invention discloses a node multi-electrode resistivity measurement system provided with a transmitter, a PC terminal, acquisition nodes, transmitting electrodes and receiving electrodes. The transmitter, acquisition nodes and PC terminal are connected by Wifi, and the transmitter and acquisition nodes are connected in series by a five-core cable. So the weight of the cable is greatly reduced, and each core can be wrapped by shielding layer, reducing the influence of electromagnetic coupling and ensuring the quality of collected data. The weight of the system is very light so that work efficiency has been improved. Synchronization between transmitter and acquisition nodes is carried out by GPS.

### FIELD OF THE INVENTION

The present invention relates to the field of geological exploration technology, especially a node multi-electrode resistivity measurement system.

### BACKGROUND OF THE INVENTION

With the progress of society and the improvement of science and technology, multi-electrode resistivity method has been widely applied in mineral, engineering and hydrogeological survey. It is convenient and fast, which can provide more intuitive reference for drilling and further survey and design. Meanwhile, it can effectively shorten the survey period and ensure the efficiency of survey work. It can also be used in geological disaster monitoring to provide protection for geological disaster management.

The principle of multi-electrode resistivity method is the same as resistivity method and time domain induced polarization method. The difference is that multi-electrode resistivity method is an array exploration method. During the measurement, all electrodes (dozens to hundreds) are placed on the observation section, and the electrode conversion device and collector are used to realize the rapid switching between the transmitting electrode and the receiving electrode and the automatic data acquisition. It can process data in real time and display the acquisition results of apparent resistivity and apparent polarizability. Compared with the traditional resistivity method and induced polarization method, the working efficiency of multi-electrode resistivity method is greatly improved.

Since multi-electrode resistivity method adopts array devices to work, the instrument design is more complex. Multi-electrode resistivity system generally includes three parts: the host, the electrode switch and the cable.

The main problem in the structure of multi-electrode resistivity measurement system is how to realize the connection between the measurement host and many electrodes. At present, there are mainly two forms:
(1) Centralized multi-electrode resistivity measurement system. It's connected to the host through the same number of wires as the electrodes (for example, 60 wires), and the electrode changeover switch consists of relays. The host outputs a certain control code, and drives the pull-in and release of different relays through the decoding circuit, thus achieving the switching of different electrodes and different pole distances.
(2) Distributed multi-electrode resistivity measurement system. In order to solve the shortcomings of centralized multi-electrode resistivity measurement system, such as many cables, bulky, fixed number of electrodes, and small power supply current, which results in low secondary voltage measurement accuracy, distributed multi-electrode resistivity measurement system has been developed. The distributed multi-electrode resistivity measurement system distributes the electrode conversion switch on the cable and electrodes. Different cables can be connected to achieve the expansion of the number of electrodes, which reduces the number and weight of the single cable to a certain extent. The design of the separation of the transmitting line and the receiving line enables the transmitting line to withstand greater current and ensure the strength of the secondary voltage; Double electrodes (metal electrode, non-polarized electrode) measurement mode ensures the accuracy of secondary voltage measurement. Compared with the centralized multi-electrode resistivity measurement system, the distributed multi-electrode resistivity measurement system increases the number of electrode conversion switches, reduces the weight of cables, and realizes the measurement of apparent polarizability.

However, the multi-electrode resistivity measurement system in the existing technology mainly has the following shortcomings:
(1) Due to the weight limitation of multi-core cables, there is no shielding layer between each core cable, so there is strong electromagnetic coupling, which causes the error of measurement voltage, especially the large influence on the secondary voltage measurement.
(2) Heavy multi-core cables affect the efficiency of the construction and require harsh construction environment.
(3) The production cost of cables is high, maintenance is difficult, and problems are difficult to troubleshoot and repair.

### SUMMARY OF THE INVENTION

The purpose of the invention is to provide a node multi-electrode resistivity measurement system to solve the above problems, such as the problems of bulky cable and strong electromagnetic coupling of the existing multi-electrode resistivity measurement system, and improve the working efficiency and the intensity of the received signal.

The invention realizes the above purpose according to the following technical scheme:

A node multi-electrode resistivity measurement system is provided with a transmitter, a PC terminal, acquisition nodes, transmitting electrodes and receiving electrodes. The transmitter, acquisition nodes and PC terminal are connected by Wifi.

The transmitter and acquisition nodes are connected in series by a five-cores cable. And synchronization between transmitter and acquisition nodes is carried out by GPS.

There are multiple acquisition nodes, transmitting electrodes and receiving electrodes, and each receiving electrode and transmitting electrode are respectively connected with the acquisition nodes. The acquisition nodes are used for conducting the transmitting or receiving electrodes, collecting the potential difference, storing and transmitting data in real time.

As a preferred option of the above technical scheme, the transmitter and the acquisition nodes are connected in series through a long line, which is a five-core cable, including 2 transmitting lines, 1 receiving line and 2 power supply line. The 2-core power supply line provides power for the work of the transmitter and the receiver. The 2-core transmitting line is connected to the power supply electrodes A and B respectively, and the 1-core receiving line is connected to all acquisition nodes and receiving electrodes. The outer layer of each core line is wrapped with a shielding layer.

As a preferred option of the above technical solution, each of the receiving electrodes and the transmitting electrodes are respectively connected to the acquisition node, specifically, each two adjacent receiving electrodes are connected to an acquisition node, and each transmitting electrode is also connected to the same acquisition node.

In the above technical scheme, the methods of using a node multi-electrode resistivity measurement system are as follows:
Q1: Complete the connection of each component of the;
Q2: Edit the configuration file required for the work, and the PC terminal reads the first configuration information;
Q3: The PC terminal controls the transmitting electrodes connected to two nodes as power supply electrodes A and B respectively, and the transmitting parameters should be set and the corresponding acquisition nodes according to the configuration information are open;
Q4: The transmitter transmits and records the current, and each node collects the voltage signal at the same time;
Q5: Monitor the signal of transmitting current and receiving voltage in real time through the PC terminal to ensure the working quality.

Q6: Apparent resistivity and apparent polarizability are calculated on PC terminal according to the results of the transmitting current and receiving voltage, combined with the arrangement device, and be displayed in the pseudo-section diagram.

Q7: The PC terminal reads the next configuration information and returns to step Q3 until the work is completed.

The invention provides a node multi-electrode resistivity measurement system with simple structure, convenient operation and ingenious design. The beneficial effects are as follows.
(1) The transmitter and the acquisition nodes are connected in series through a long line, which is a five-core cable, thus getting rid of the dependence of the existing node multi-electrode resistivity measurement system on multi-core cables. The weight of the cable is greatly reduced, and each core wire can be wrapped with a shielding layer, which reduces the impact of electromagnetic coupling on the data and ensures the quality of the collected data; reduces the weight and reduces the work cost.
(2) The nodes are controlled by the PC terminal. The acquisition of different nodes is independent of each other, so the data can be collected at the same time to improve the efficiency. And it is convenient for system upkeep and update. The nodes are independent of each other, so the data can be collected at the same time to improve the efficiency
(3) The transmitter, all acquisition nodes and PC terminals are connected by Wifi without using communication lines. The repeater can amplify the Wifi signal and avoid communication delays and interruptions caused by far distances. PC terminal can control transmitter and each node in real time, and view the data results. Within the allowable processing range of PC terminals, nodes can be continuously increased, which is convenient for promotion and use.

### BRIEF DESCRIPTION OF THE FIGURES

In order to illustrate the embodiments of the present invention or the technical solutions in the existing technology more clearly, the attached drawings used in the embodiments or the existing technical description are briefly introduced below. Obviously, the drawings in the following description are only some embodiments of the present invention. For ordinary technical personnel in this field, other drawings can also be obtained according to these drawings without paying creative effort.

FIG. 1 is a schematic diagram of the overall structure of a node multi-electrode resistivity measurement system according to the embodiment of the present invention.

### DESCRIPTION OF THE INVENTION

In order to make the purpose, features and advantages of the present invention more obvious and understandable, the technical schemes in the embodiments of the present invention will be clearly and completely described below with reference to the attached drawings in the embodiments of the present invention. Obviously, the embodiment described in the following is only part of the embodiment of the invention, rather than all the embodiments. Based on the embodiments of the invention, all other embodiments obtained by ordinary technicians in this field without creative labor shall fall within the scope of the protection of the invention.

The technical scheme of the invention is further explained in combination with the attached drawings and through specific embodiments.

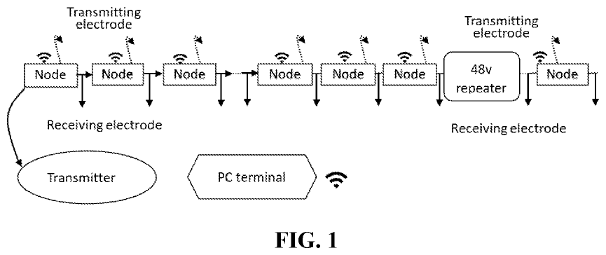

Please refer to FIG. 1, the present invention discloses a node multi-electrode resistivity measurement system, and its embodiments are as follows:
1. Edit the configuration file before construction, including configuration information such as transmitting position, receiving position, sampling rate, gain, etc., and import the configuration file into the PC terminal.
2. Connect the device as shown in FIG. 1. Place the node and transmitting and receiving electrodes at the working point and connect the node with the transmitting and receiving electrodes and cables, turn on the node, and add WIFI repeaters at the appropriate locations.
3. The transmitter and the acquisition node are connected in series through a five-core cable.
4. The PC terminal connects the transmitter and all nodes by Wifi, and uses the control software to detect the grounding of each transmitting electrode and receiving electrode. After there is no error, the control software reads the first configuration information, guides the corresponding transmitting electrode according to the transmitting position and receiving position, and controls the corresponding nodes to collect data. The time series of the transmitting current and the receiving voltage can be viewed by PC terminal in real time. After the acquisition is completed, the apparent resistivity and apparent polarization are displayed and marked in the quasi-section diagram.
5. Then reads the next configuration information, by analogy, until the whole profile measurement is completed.

For technical personnel in this field, it is obvious that the invention is not limited to the details of the above embodiments, and it can be realized in other specific forms without deviating from the spirit or basic characteristics of the invention. Therefore, no matter from which point of view the embodiments are to be regarded in all respects as illustrative and not restrictive, and the scope of the invention is defined by the attached claims rather than the foregoing description, which are therefore intended to fall within the scope of the attached claims. All changes within the meaning and scope of the same requirements are included in the present invention. Any reference marks in the claims should not be regarded as limiting the claims.

The above embodiments are used only to describe the technical scheme of the invention, not to restrict it; Although the invention is described in detail according to the above embodiments, the ordinary technicians in this field should understand that: it is still possible to modify the technical scheme recorded in the above embodiments, or equivalently replace some of the technical features; However, these modifications or replacements do not deviate the essence of the corresponding technical scheme from the spirit and scope of the technical scheme of each embodiment of the invention.

1. The characteristic of node multi-electrode resistivity measurement system is that it is provided with a transmitter, a PC terminal, acquisition nodes, transmitting electrodes and receiving electrodes. The transmitter, acquisition nodes and PC terminal are connected by Wifi;
the transmitter and acquisition nodes are connected in series by a five-cores cable. And synchronization between transmitter and acquisition nodes is carried out by GPS;
the transmitter, acquisition nodes and PC terminal are connected by Wifi;
there are multiple acquisition nodes, transmitting electrodes and receiving electrodes, and each receiving electrode and transmitting electrode are respectively connected to the acquisition nodes. The acquisition nodes are used for conducting the transmitting or receiving electrodes, collecting the potential difference, storing and transmitting data in real time.

2. According to claim 1, the characteristic of a node multi-electrode resistivity measurement system is that the transmitter and the acquisition nodes are connected in series by a five-core cable, including 2 transmitting lines, 1 receiving line and 2 power supply lines. The 2-corepower supply lines provide power for the work of the transmitter and the acquisition nodes. The 2-core transmitting lines are connected to the power supply electrodes A and B respectively, and the 1-core receiving line is connected to all acquisition nodes and receiving electrodes. Each core is wrapped by shielding layer.

3. According to claim 1, the characteristic of a node multi-electrode resistivity measurement system is that each of the receiving electrodes and the transmitting electrodes are respectively connected to the acquisition node, specifically, each two adjacent receiving electrodes are connected to an acquisition node and each transmitting electrode is also connected to the same acquisition node.

4. According to claim 1, the methods of using a node multi-electrode resistivity measurement system are as follows:
Q1: Complete the connection of each component of the system;
Q2: Edit the configuration file required for the work, and the PC terminal reads the first configuration information;
Q3: The PC terminal controls the transmitting electrodes connected to two nodes as power supply electrodes A and B respectively, and the transmitting parameters should be set and corresponding acquisition nodes according to the configuration information are open;
Q4: The transmitter transmits and records the current, and each node collects the voltage signal at the same time;
Q5: Monitor the signal of transmitting current and receiving voltage in real time through the PC terminal to ensure the working quality;
Q6: Apparent resistivity and apparent polarizability are calculated on PC terminal according to the results of the transmitting current and receiving voltage, combined with the arrangement device, and be displayed in the pseudo-section diagram;
Q7: The PC terminal reads the next configuration information and returns to step Q3 until the work is completed.
